(19) United States
(12) Patent Application Publication
(10) Pub. No.: US 2025/0296159 A1
(43) Pub. Date: Sep. 25, 2025

(54) MILLING TOOL

(71) Applicant: CERATIZIT AUSTRIA GESELLSCHAFT M.B.H., Reutte (AT)

(72) Inventors: Peter BURTSCHER, Reutte (AT); Roland FRIEDL, Reutte (AT)

(21) Appl. No.: 18/864,288

(22) PCT Filed: Mar. 28, 2023
(86) PCT No.: PCT/EP2023/057988

§ 371 Date: Nov. 8, 2024

(30) Foreign Application Priority Data
May 24, 2022 (EP) 22175019.3

(51) Int. Cl. B23C 5/06; B23C 5/22

(52) U.S. Cl. CPC B23C 5/06; B23C 5/2243; B23C 2210/166

(57) ABSTRACT

A milling tool has a milling tool main element which has a first end with an interface for connection to a machine-side tool holder, and a free second end with at least one seat for receiving an exchangeable cutting insert. The following are arranged at the seat: a first support element for supporting a first side face of the cutting insert, which first support element is reversibly fastened to the milling tool main element by a first fastening element, a second support element for supporting a second side face of the cutting insert, which second support element is reversibly fastened to the milling tool main element by a second fastening element, and a third support element for supporting an underside of the cutting insert. The third support element is reversibly fastened to the milling tool main element by a third fastening element.

The present invention relates to a milling tool having a milling tool main body which has a first end that has an interface for connecting to a machine-proximal tool receptacle and a free second end that has at least one seat for receiving an interchangeable cutting insert.

Milling tools which have a milling tool main body, on the free end of which are disposed interchangeable cutting inserts that have the cutting edges which come to engage with the material to be machined are often used in particular for machining metallic materials, or else for machining composite materials, for example. The milling tool main body herein is typically made of a relatively tough material such as tool steel, for example, and the interchangeable cutting inserts are formed from a significantly harder material such as, for example, hard metal (cemented carbide), Cermet or a cutting ceramic. Depending on the material to be machined, super-hard cutting materials such as polycrystalline diamond (PKD) or cubic boron nitride (CBN) may also be used at times in the cutting sector.

The interchangeable cutting inserts are typically held in seats that are formed on the external circumference of the milling tool main body. For reversibly fastening the cutting inserts, fastening screws which penetrate a through-bore in the respective cutting insert are at times used, or alternatively so-called clamping jaws or clamping wedges, which act in a force-fitting manner and in some instances also in a form-fitting manner on one side of the respective cutting insert.

In order to in particular enable adjustability of the position of the cutting insert, for example, solutions in which the cutting insert is not fastened directly to a seat on the milling tool main body, but rather to a cutting insert seat on an interchangeable cartridge which is then fastened to the milling tool main body, are also used at times. In such a design embodiment, the interchangeable cutting insert usually bears on corresponding lateral bearing faces of the cartridge by way of at least two lateral faces, and is often also supported on the cartridge by way of the lower side of said interchangeable cutting insert.

It can occur in particular in milling tools for heavy subtractive machining that a cutting insert breaks due to the large acting forces during operation. In this case, there is often also damage to the adjacent regions of the reversing plate and/or to a cartridge in which the cutting insert is held, which is associated with relatively high costs. Furthermore, in the known milling tools it is in most cases not possible to use different types of interchangeable cutting inserts, or a modification is possible only with very high complexity, respectively.

It is an object of the present invention to provide an improved milling tool in which the costs in the event of a breakage of an interchangeable cutting insert are reduced and which enables a simple modification for different interchangeable cutting inserts.

The object is achieved by a milling tool as claimed in claim 1. Advantageous refinements are set forth in the dependent claims.

The milling tool has a milling tool main body which has a first end that has an interface for connecting to a machine-proximal tool receptacle, and a free second end that has at least one seat for receiving an interchangeable cutting insert. Disposed on the seat are: a first support member for supporting a first lateral face of the cutting insert which is reversibly fastened by way of a first fastening element to the milling tool main body, a second support member for supporting a second lateral face of the cutting insert which is reversibly fastened by way of a second fastening element to the milling tool main body, and a third support member for supporting a lower side of the cutting insert which is reversibly fastened by way of a third fastening element to the milling tool main body.

Owing to the first, second and third support members which are provided separately from one another and are in each case reversibly fastened by way of assigned fastening elements to the milling tool main body, only that region, for example only one of the support members, that has likewise been damaged can be replaced in the case of a breakage of an interchangeable cutting insert in a targeted manner. Furthermore, by replacing one or a plurality of the support members, the seat can be converted in a particularly simple manner for receiving an interchangeable cutting insert with a different shape.

According to one refinement, the first, the second and the third fastening element are in each case formed as screws. Particularly easy handling is enabled in this case.

According to one refinement, the first, the second and the third fastening element are in each case formed with an engagement region for a screw-driving tool, and the engagement regions are conceived to engage with the same screw-driving tool. In this case, the milling tool is conceived to be particularly user-friendly, and there is no need to have available a large number of different screw-driving tools.

According to one refinement, a clamping wedge for exerting a clamping force on an upper side of the cutting insert is disposed in the region of the seat. Particularly robust and reliable fastening of the cutting insert to the milling tool main body is guaranteed in this case.

According to one refinement, the clamping wedge is connected to the milling tool main body by way of a screw element. Particularly simple and user-friendly operation for replacing the cutting insert is enabled in this case. The screw element can preferably have an engagement region for a screw-driving tool, which enables an activation using the same screw-driving tool that is also used for the respective fastening elements of the support members.

According to one refinement, the screw element has a first threaded region which interacts with a threaded portion in the clamping wedge, and a second threaded region which interacts with a threaded portion in the milling tool main body. A particularly simple activation of the clamping wedge by way of the screw element is enabled in this case.

According to one refinement, the first threaded region and the second threaded region of the screw element differ from one another in the rotation direction of the thread and/or the thread pitch. A movement of the clamping wedge for fastening and releasing the interchangeable cutting insert is provided in a particular simple and reliable manner in this case.

According to one refinement, the third support member is in each case laterally supported on the first support member and on the second support member. Particularly easy replacement of the third support member is enabled in this case, on the one hand, and also particularly compact and robust fastening of the cutting insert is implemented, on the other hand.

According to one refinement, the third fastening element is disposed obliquely in such a manner that the third support member is tensioned in the direction of the first support member and in the direction of the second support member. Good accessibility of the third fastening element is provided in this case, and the cutting insert is supported in a particularly robust and reliable manner.

According to one refinement, provided are a first set of a first support member, a second support member and a third support member and at least one further set, which is different from the first set, of a first support member, a second support member and a third support member for adapting the seat for receiving different cutting inserts. All the support members of the further set herein can differ from the corresponding support members in the first set, for example, or alternatively only one or two of the support members can differ from the corresponding support members in the first set, for example. When the first set of support members and the at least one further set of support members are provided, a conversion to different types of interchangeable cutting inserts can be performed in a particularly simple and fast manner.

According to one refinement, provided on the second end are a plurality of seats which are distributed across the circumference of the milling tool main body for receiving interchangeable cutting inserts. The seats herein can in particular all be designed in the same manner. The seats can preferably be designed for receiving identical cutting inserts and with the same orientation. A particularly efficient subtractive machining process is enabled in this case.

When the first support member and the second support member are of identical design, particularly simple and user-friendly handling is provided, and production costs can be kept low.

According to one refinement, the seat on the milling tool main body is generated entirely by hobbing from one machine direction. Particularly cost-effective production is enabled in this case.

Further advantages and expedient features of the invention are derived by means of the description hereunder of an exemplary embodiment with reference to the appended figures.

In the figures:

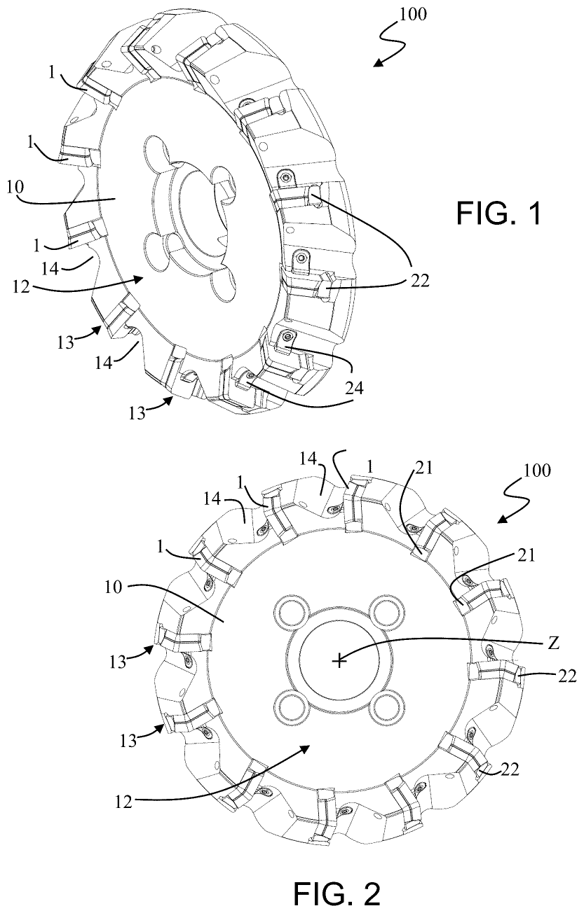

FIG. 1: shows a perspective illustration of a milling tool having a plurality of interchangeable cutting inserts which are fastened to corresponding reversing plates;

FIG. 2: shows a schematic end-side view of the milling tool from FIG. 1;

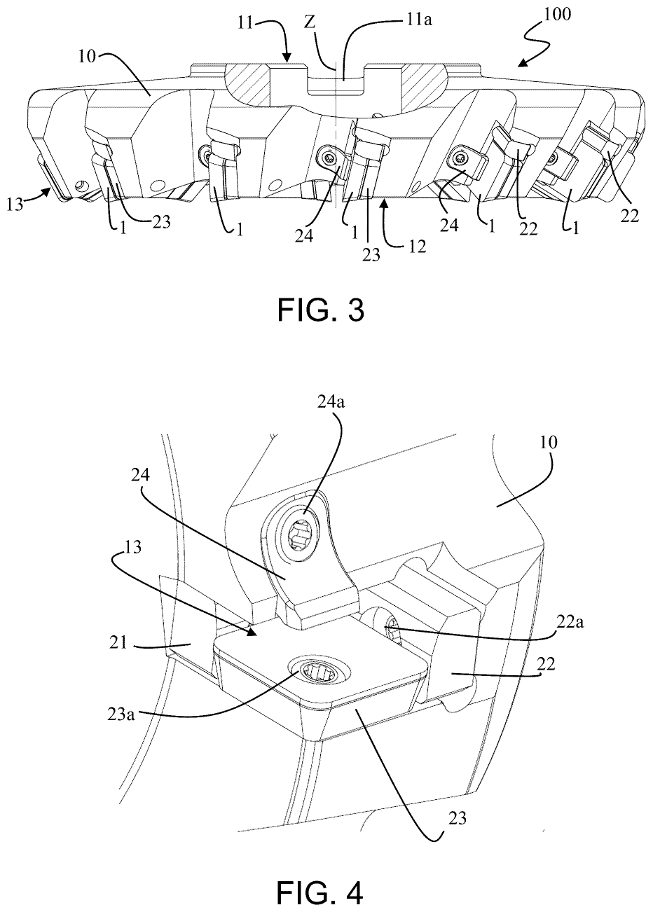

FIG. 3: shows a partially sectional lateral view of the milling tool from FIG. 1;

FIG. 4: shows an enlarged detailed illustration in the region of a seat on the milling tool main body, without an interchangeable cutting insert fastened thereto;

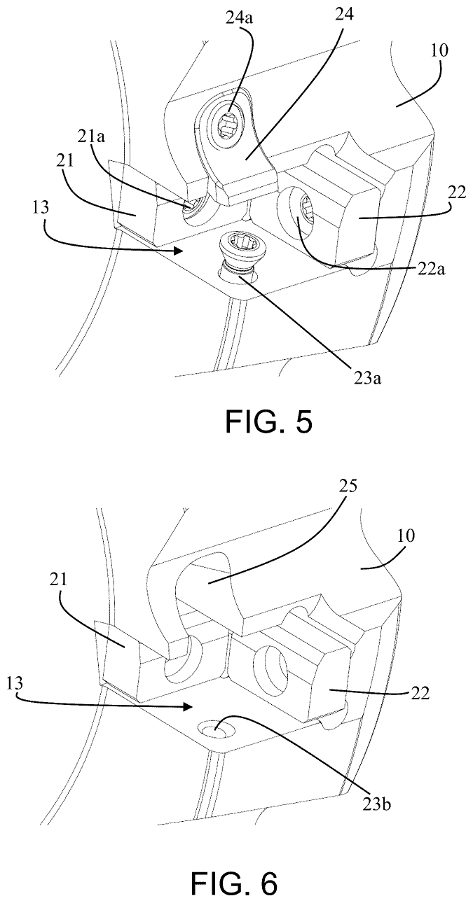

FIG. 5: shows an illustration corresponding to FIG. 4, but without a third support member;

FIG. 6: shows an illustration corresponding to FIG. 4 and FIG. 5, wherein only the first support member and the second support member are still disposed in the region of the seat;

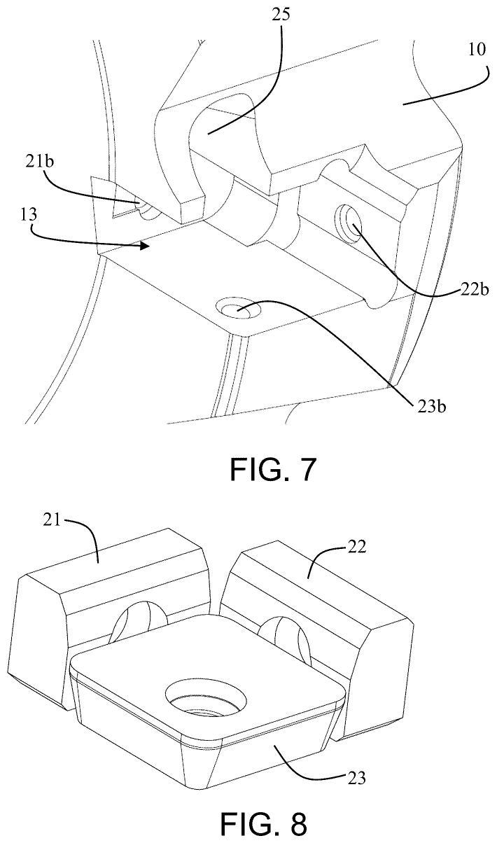

FIG. 7: shows a schematic perspective detailed illustration in the region of the seat, without support member, fastening means, cutting insert and clamping wedge;

FIG. 8: shows a schematic illustration of the arrangement of the first, second and third support member in the embodiment;

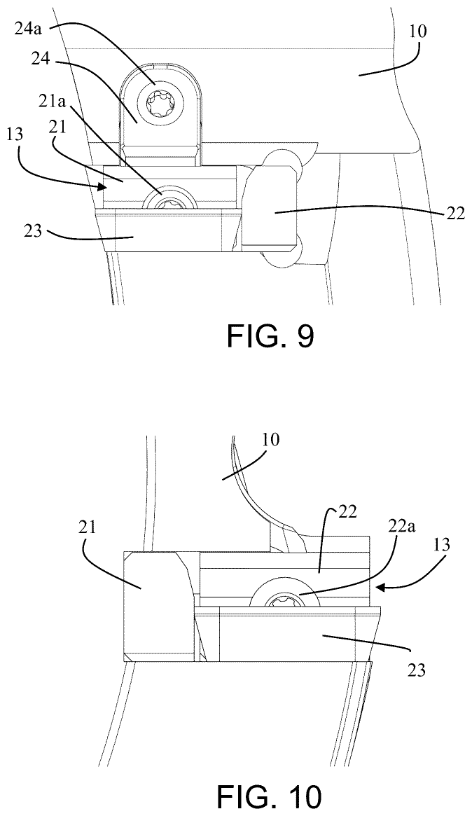

FIG. 9: shows a schematic lateral view in the region of a seat, without a cutting insert fastened thereto, having a substantially radial direction of view in terms of a rotation axis of the milling tool;

FIG. 10: shows a schematic frontal view in the region of a seat, without a cutting insert fastened thereto, having a substantially axial direction of view in terms of a rotation axis of the milling tool;

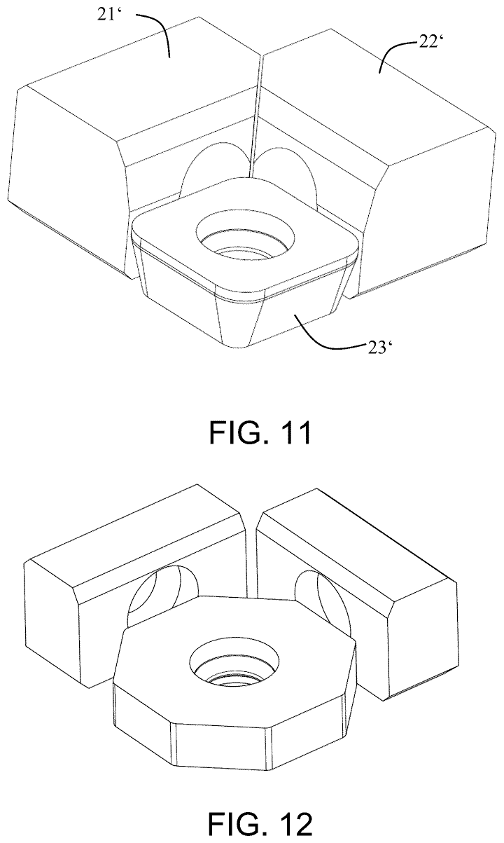

FIG. 11: shows a schematic illustration of a further set of a first, a second and a third support member for adapting the seat to another cutting insert; and

FIG. 12: shows a schematic illustration of yet a further set of a first, a second and a third support member for adapting the seat to yet another cutting insert.

### EMBODIMENT

An embodiment of the milling tool will be described in more detail hereunder with reference to FIG. 1 to FIG. 10.

As can be seen in particular in FIG. 1 to FIG. 3, the milling tool 100 in the embodiment illustrated is designed as a so-called arbor mounting and has a corresponding interface for connecting to the drive of a machine tool. Even though such a design embodiment in the specific exemplary embodiment is shown as an arbor mounting, the milling tool 100 can also be provided with any other customary interface.

The milling tool 100 has a milling tool main body 10 which can be formed from a tool steel, for example. The milling tool main body 10 has a first end 11 that is provided with the interface 11a for connecting to the drive of a machine tool, and a free second end 12. A plurality of seats 13 for receiving interchangeable cutting inserts 1 is formed on the free second end 12 of the milling tool main body 10.

Even though a total of twelve such seats 13 are provided in the specifically illustrated exemplary embodiment, there may also be fewer than twelve seats 13 or more than twelve seats 13 provided, depending on the intended use. The seats are disposed on the free second end 12 so as to be distributed across the external circumference of the milling tool main body 10 in such a manner that cutting inserts 1 disposed on the latter project from the milling tool main body 10 in each case by way of an active cutting-edge region in the axial direction as well as in the radial direction in terms of a rotation axis Z of the milling tool 100. In the exemplary embodiment illustrated, the seats 13 are disposed so as to be distributed substantially uniformly across the circumference and designed for receiving identical cutting inserts 1.

Chip flutes 14 which serve to discharge chips generated during the operation of the milling tool 100 are formed adjacent to the seats 13 in the milling tool main body 10.

As can be seen in particular in the enlarged detailed illustration in the region of a seat 13 in FIG. 4, a first support member 21 for supporting a first lateral face of the cutting insert 1 on the milling tool main body 10 is disposed in the region of the seat 13. The first support member 21 is reversibly fastened to the milling tool main body 10 by way of a first fastening element 21a. In the exemplary embodiment, the first fastening element 21a is formed as a screw which by way of a threaded portion penetrates a through-bore in the first support member 21 and engages in a corresponding threaded bore 21b which is formed in the milling tool main body 10 and can be seen in FIG. 7. A head of the first fastening element 21a here is supported on the internal wall of the through-bore in the first support member 21, so as to tension the latter in relation to the milling tool main body 10. The head of the first fastening element 21a is provided with an engagement region for a screw-driving tool by way of which the first fastening element 21a can be activated. Even though a specific design embodiment of the engagement region is illustrated by way of example, the latter can also be designed in another way, for example in the form of a hexagonal socket, a cross head, etc.

Furthermore, a second support member 22 for supporting a second lateral face of the cutting insert 1, different from the first lateral face, is disposed on the milling tool main body 10 in the region of the seat 13. The second support member 22 is reversibly fastened to the milling tool main body 10 by way of a second fastening element 22a. In the exemplary embodiment, the second fastening element 22a is likewise formed as a screw which by way of a threaded portion penetrates a through-bore in the second support member 22 and engages in a corresponding threaded bore 22b which is formed in the milling tool main body 10 and can be seen in FIG. 7. A head of the second fastening element 22a here is supported on the internal wall of the through-bore in the second support member 22, so as to tension the latter in relation to the milling tool main body 10. The head of the second fastening element 22a is provided with an engagement region for a screw-driving tool by way of which the second fastening element 22a can be activated. In the embodiment, the engagement region of the second fastening element 22a is of identical design to that of the first fastening element 21a, so that the same screw-driving tool can be used for their activation.

Moreover, a third support member 23 for supporting a rear side of the cutting insert 1 is disposed on the milling tool main body 10 in the region of the seat 13. The third support member 23 is reversibly fastened to the milling tool main body 10 by way of a third fastening element 23a. In the exemplary embodiment, the third fastening element 23a is likewise formed as a screw which by way of a threaded portion penetrates a through-bore in the third support member 23 and engages in a corresponding threaded bore 23b which is formed in the milling tool main body 10 and can be seen in FIG. 7. A head of the third fastening element 23a here is supported on the internal wall of the through-bore in the third support member 23, so as to tension the latter in relation to the milling tool main body 10. The head of the third fastening element 23a is provided with an engagement region for a screw-driving tool by way of which the third fastening element 23a can be activated. In the embodiment, the engagement region of the third fastening element 23a is of identical design to that of the first fastening element 21a and that of the second fastening element 22a, so that the same screw-driving tool can in each case be used for their activation.

The third support member 23 in the exemplary embodiment is designed as a shim which in terms of its shape is adapted to the shape of the cutting insert 1 in such a manner that said shim supports the cutting insert in a substantially fully planar manner on the seat 13. As can be seen in particular in FIG. 4, FIG. 8, FIG. 9 and FIG. 10, the third support member 23 in the fastened state is supported on the first support member 21 as well as on the second support member 22. The threaded bore 23b for the third fastening element 23a herein is designed to be slightly tilted obliquely in relation to the bearing face for the third support member 23, as can be seen in FIG. 5, so that the third support member 23 is tensioned in the direction of the first support member 21 and in the direction of the second support member 22 when tightening the third fastening element 23a. The obliquely tilted design embodiment of this threaded bore 23b moreover enables the engagement region of the third fastening element 23a to be readily accessible for its activation.

In the embodiment, the first support member 21 and the second support member 22 are of identical design, which additionally facilitates handling and has a positive effect on the production costs.

As can be seen in particular in FIG. 4, FIG. 5 and FIG. 9, a clamping wedge 24 which is designed to fix the cutting insert 1 on the seat 13 is disposed in the region of the seat 13. The clamping wedge 24 is guided in a clearance 25 on the milling tool main body 10 and can be activated by way of a screw element 24a by way of which the clamping wedge 24 is fastened to the milling tool main body 10. The clamping wedge 24 possesses as a threaded portion a bore which is provided with an internal thread and in which an upper shank portion of the screw element 24a that is provided with a first threaded region, formed as a corresponding external thread, is received. A threaded bore in the milling tool main body 10 is formed as a threaded portion in which a lower shank portion of the screw element 24a engages by way of a second threaded region which is formed as a corresponding external thread. In order to obtain a movement of the clamping wedge 24 along a longitudinal axis of the screw element 24a when the screw element 24a is activated, the first threaded region and the second threaded region of the screw element 24a are embodied with different rotation direction of the thread, i.e., one of the two threaded regions is designed as a left-hand thread and the other as a right-hand thread. The same applies to the threaded portions in the clamping wedge 24 and in the milling tool main body 10, which interact in each case with the first threaded region and the second threaded region.

A guide face for the clamping wedge 24 in the clearance 25 extends at an angle in relation to the upper side of the third support member 23 in such a way that the clamping wedge 24 approaches the third support member 23 and can in this way fix the cutting insert 1 when the screw element 24a is tightened. The fixing of the cutting insert 1 can be performed, for example, exclusively in a force-fitting manner by exerting a clamping force on the upper side of the cutting insert 1, or the surface of the clamping wedge 24 that faces the cutting insert 1 can additionally also interact in a form-fitting manner with the upper side of the cutting insert 1.

In the embodiment, the screw element 24a for activating the clamping wedge 24 is provided with an engagement region for a screw-driving tool which enables an activation using the same screw-driving tool that can also be used for the fastening elements 21a, 22a and 23a, so that particularly comfortable and simple operation is enabled.

Even though the movement of the clamping wedge 24 along the longitudinal axis of the screw element 24a in the specific exemplary embodiment is provided by way of the different rotation direction of the first and second threaded region, it is also possible, for example, to provide the first and the second threaded region with the same rotation direction but to provide a different thread pitch.

As can be seen in FIG. 11, provided in the embodiment is furthermore at least one further set of a first support member 21′, a second support member 22′ and a third support member 23′, which is different from the above-described first set of the first support member 21, the second support member 22 and the third support member 23. In this way, the milling tool can be converted in a very simple and rapid manner for receiving cutting inserts 1 with different shapes and/or dimensions.

Provided in FIG. 12 is yet a further set of a first support member 21″, a second support member 22″ and a third support member 23″, which is different from the above-described sets of first, second and third support members. The set which is schematically illustrated in FIG. 12 is designed for adapting the seat for receiving an interchangeable cutting insert with a substantially octagonal shape.

As can be seen in particular in FIG. 7, the seat 13 in the milling tool main body 10 has a shape which is produced entirely by hobbing from one direction.

1-13 (canceled)

14. A milling tool, comprising:
a milling tool main body having a first end with an interface for connecting to a machine-proximal tool receptacle, and a free second end having at least one seat for receiving an interchangeable cutting insert;
a first support member, disposed on said at least one seat, for supporting a first lateral face of the interchangeable cutting insert, said first support member being reversibly fastened by way of a first fastening element to said milling tool main body;
a second support member, disposed on said at least one seat, for supporting a second lateral face of the interchangeable cutting insert, said second support member being reversibly fastened by way of a second fastening element to said milling tool main body; and
a third support member, disposed on said at least one seat, for supporting a lower side of the interchangeable cutting insert, said third support member being reversibly fastened by way of a third fastening element to said milling tool main body.

15. The milling tool according to claim 14, wherein said first fastening element, said second fastening element and said third fastening element are in each case formed as screws.

16. The milling tool according to claim 14, wherein said first fastening element, said second fastening element and said third fastening element are in each case formed with an engagement region for a screw-driving tool, and said engagement region is conceived to engage with the screw-driving tool.

17. The milling tool according to claim 14, further comprising a clamping wedge for exerting a clamping force on an upper side of the interchangeable cutting insert is disposed in a region of said at least one seat.

18. The milling tool according to claim 17, further comprising a screw element, said clamping wedge is connected to said milling tool main body by way of said screw element.

19. The milling tool according to claim 18, wherein:
said clamping wedge has a threaded portion;
said milling tool main body has a threaded portion; and
said screw element has a first threaded region which interacts with said threaded portion in said clamping wedge, and a second threaded region which interacts with said threaded portion in said milling tool main body.

20. The milling tool according to claim 19, wherein said first threaded region and said second threaded region of said screw element differ from one another in a rotation direction of a thread and/or a thread pitch.

21. The milling tool according to claim 14, wherein said third support member is laterally supported on both said first support member and said second support member.

22. The milling tool according to claim 14, wherein said third fastening element is disposed obliquely in such a manner that said third support member is tensioned in a direction of said first support member and in a direction of said second support member.

23. The milling tool according to claim 14, further comprising:
a first set of said first support member, said second support member and said third support member; and
at least one further set, which is different from said first set, of a further first support member, a further second support member and a further third support member for adapting said at least one seat for receiving different cutting inserts.

24. The milling tool according to claim 14, wherein said at least one seat is one of a plurality of seats on said second end, said plurality of seats are distributed across a circumference of said milling tool main body, for receiving interchangeable cutting inserts.

25. The milling tool according to claim 14, wherein said first support member and said second support member are of identical design.

26. The milling tool according to claim 14, wherein said at least one seat on said milling tool main body is generated entirely by hobbing from one machining direction.
